(19) United States
(12) Patent Application Publication
(10) Pub. No.: US 2010/0037213 A1
(43) Pub. Date: Feb. 11, 2010

(54) GRAMMAR-BASED GENERATION OF TYPES AND EXTENSIONS

(75) Inventors: Henricus Johannes Maria Meijer, Mercer Island, WA (US); John Wesley Dyer, Monroe, WA (US); Thomas Meschter, Renton, WA (US); Cyrus Najmabadi, New York, NY (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/187,875

(22) Filed: Aug. 7, 2008

(51) Int. Cl. G06F 9/45

(52) U.S. Cl. 717/144

(57) ABSTRACT

Parsing functionality is automatically generated. In particular, abstract syntax tree types and/or other programmatic constructs are created automatically from a grammar specification in a manner that resembles hand-written code. An abstract syntax tree can subsequently be constructed as a function of the generated types. Further, a plurality of supporting functionality can be generated to consume or produce abstract syntax tree types, among other things.

### BACKGROUND

A compiler conventionally produces code for a specific target from source code. For example, some compilers transform source code into native code for execution by a specific machine. Other compilers generate intermediate code from source code, where this intermediate code is subsequently interpreted dynamically at runtime or compiled just in time (JIT) to facilitate execution across computer platforms, for instance. Further yet, some compilers are utilized by integrated development environments (IDEs) to perform background compilation to aid programmers by identifying actual or potential issues, among other things.

Compilers perform lexical, syntactic, and semantic program analysis followed by code generation. Lexical analysis involves converting a stream of characters into a stream of tokens. Syntactic analysis is a process of analyzing the stream of tokens in an attempt to recognize formal structure in accordance with a formal grammar. Semantic analysis is a compiler phase that determines and analyzes semantic information concerning meaning of the formal structure. Subsequently, code can be generated in a target language for execution, for example.

Syntactic analysis is performed by a parser or parse system. Parsers enable either recognition or transcription of patterns matching formal grammars. One form of transcription is production of a parse tree or abstract syntax tree (AST). Generally, both trees provide a formal structure from which subsequent analysis can be performed, but they are different. Parse trees are records of productions and tokens that match some input. They encode every rule and step utilized to analyze the input. By contrast, ASTs capture input structure in a manner that is insensitive to a grammar and/or parser that produced it. Thus, abstract syntax trees capture the syntactic essence of the input, while parse trees include often unnecessary processing details.

To construct an abstract syntax tree, much boilerplate code is utilized. More specifically, a programmer is responsible for specifying both the types that go into the AST and construction of those types, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to grammar-based generation of types and extensions. In particular, types and/or other programmatic constructs can be generated automatically as a function of a grammar or grammar specification in a manner that resembles a hand-written encoding rather than a naïve translation. An abstract syntax tree can subsequently be generated as a function of the automatically generated constructs. Furthermore, a plurality of supporting functionality can be generated automatically relating to consumption and/or production of abstract syntax tress, among other things. For example, various visitors, factories, rewriters, canonical representations, and debugging proxies can be constructed to aid use and interaction with abstract syntax trees.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a parser generator system in accordance with an aspect of the disclosure.

FIG. 2 is a block diagram of a representative type generator component according to a disclosed aspect.

FIG. 3 is a UML diagram of an object model produced for an example grammar in accordance with an aspect of the disclosure.

FIG. 4 is a block diagram of an extended parser generation system according to an aspect of the subject disclosure.

FIG. 5 is a block diagram of a plurality for exemplary extension components that can be employed with respect to a parser generation system in accordance with an aspect of the disclosure.

FIG. 6 is a flow chart diagram of a parser generation method according to an aspect of the disclosure.

FIG. 7 is a flow chart diagram of a method of automatic type generation in accordance with an aspect of the subject disclosure.

FIG. 8 is a flow chart diagram of a method of automatic pattern encoding according to a disclosed aspect.

FIG. 9 is a flow chart diagram of an extension method in accordance with a disclosed aspect.

FIG. 10 is a flow chart diagram of a method of generating a canonical representation of a token in accordance with an aspect of the disclosure.

FIG. 11 is a flow chart diagram of a method of generating a canonical representation of an abstract syntax tree node according to a disclosed aspect.

FIG. 12 is a schematic block diagram illustrating a suitable operating environment for aspects of the subject disclosure.

FIG. 13 is a schematic block diagram of a sample-computing environment.

### DETAILED DESCRIPTION

Systems and methods pertaining to automatic generation of parser functionality are described in detail hereinafter. Types can be generated automatically from a grammar or grammatical specification that facilitates construction of an abstract syntax tree. Moreover, type generation reasons over the grammar to enable production of an object model that resembles a hand-generated model rather than performing a naïve translation of the grammar to types. Furthermore, many extension points can also be generated from the grammar including, without limitation, encoding of grammatical patterns, generation of visitors, factories, and rewriters, construction of canonical representations, and generation of helper mechanisms to facilitate debugging of types, among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

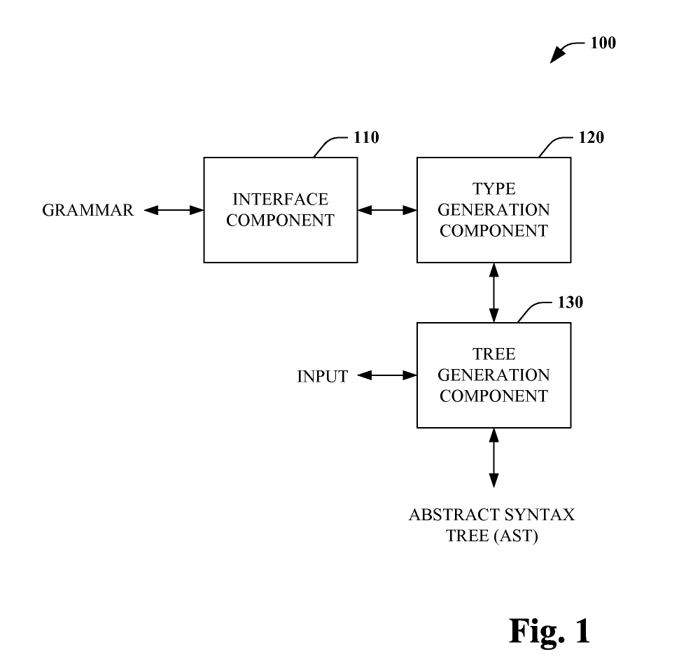

Referring initially to FIG. 1, a parser generator system 100 is illustrated in accordance with an aspect of the claimed subject matter. Parsers enable either recognition or transcription of patterns matching formal grammars. One instance of transcription is generation of abstract syntax trees (ASTs). System 100 enables automatic generation of such trees and supporting mechanisms. As shown, the system 100 includes an interface component 110 communicatively coupled to the type generation component 120. The interface component 110 provides a means for type generation component 120 to interact with a grammar or grammar specification associated with a programming language, natural language, or data (e.g., XML, JSON, comma-separated files). The type generation component 120 analyzes the grammar afforded via the interface component 110 and constructs one or more data types associated with an AST based on the grammar. Tree generation component 130 can employ types and other functionality provided by the type generation component 120 to construct an AST for a given input.

Conventionally parser generation can be performed manually or automatically. Typically, such systems require users to specify an AST and corresponding AST consumers themselves. While the creation of an AST is a relatively straightforward process, it requires a large amount of boilerplate code both to specify AST types and construction of those types. This introduces opportunities for of bugs or other problems. One the other hand, systems that automatically generate AST types generate something that is closer to a parse tree than an AST. ASTs are more general than the grammar because they allow construction of things that are not parseable. For example, consider the exemplary context-free grammar below where “+”, “*”, “n”, “(“, and “)” are tokens:

$$E -> E + T \\ \vert T$$

$$T -> T * F \\ \vert F$$

$$F -> n \\ \vert v \\ \vert ( E )$$

This grammar typically produces four types (e.g., Expression, Term, Factor), but programmers would prefer one type (e.g., Expression) that allows construction of a combination of expressions through grouping, addition, multiplication, numbers, or variables. System 100 differs from conventional automated approaches in that type generation component 120 does not perform a naïve translation when generating types but rather reasons over the grammar to produce a set of types or object model close to what a hand-written model would look like. As a result, system 100 provides benefits associated with both hand-written and automatic generation of types.

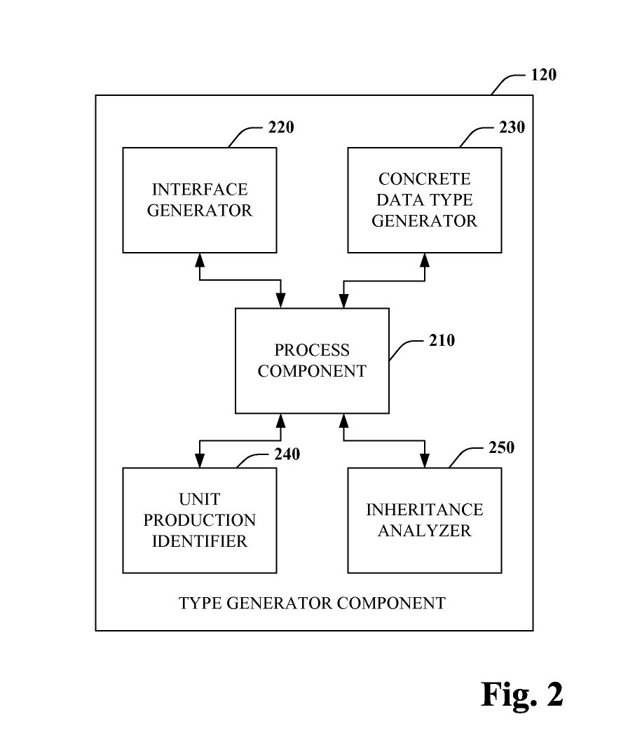

Turning attention to FIG. 2, a representative type-generator component 120 is illustrated in accordance with an aspect of the claimed subject matter. The generator component 120 includes a process component 210 that coordinates generation or construction of various types. The process component 210 further can employ the services of interface generator 220, concrete data type generator 230, unit production identifier 240, and inheritance analyzer 250 (each of which can be a component as defined herein). More specifically, the process component 210 can employ the interface generator 220 to generate interfaces for each non-terminal and token specified by a grammar. Further, concrete data type generator 230 can be commissioned by the process component 210 to construct concrete data types for each production and token specified. Unit production identifier 240 can be employed to identify unit productions and concrete data types for such productions. The process component 210 can then remove the concrete data types associated there with and encode the relationship by way of inheritance through interfaces. Of course, process component 210 could perform this process during initial generation of concrete types so as to avoid creating a type only to later remove the same type. The inheritance analyzer 250 identifies interfaces that inherit from exactly one other interface for removal by the process component 210. The process component 210 can also make each symbol of a production a member of the concrete type with the interface type of the corresponding symbol. Further, members common to all concrete types that implement an interface can be hoisted to the interface. Still further yet, the type generator component 120 can create common methods such as “Equals” “GetHashCode”, and “ToString”.

By way of example and not limitation, consider the exemplary grammar provided supra. From this grammar, the type generator component 120 can produce interfaces “IE”, “IT”, “IF”, “I*”, “In”, “Iv” “I(”, and “I)”, as well as concrete data types “+”, “*”,”(“,“)”, “n”, “v”, “(E+T)”, “T”, “(T * F)”, “F”, and “(E)” initially. Now, concrete types that correspond to unit productions can be removed, namely “T” and “F”, and encoded using inheritance through interfaces. Accordingly, the following inheritance can be declared: “IT:IE”, “IF:IT”, “In:IF” and “Iv:IF”. Next, interfaces can be removed that inherit from exactly on other interface. Hence, “IT”, “IF”, “In” and “Iv” are removed. This leaves “IE” and the concrete types that, with the exception of “*”, “+”, “(“, and “)”, all implement “IE”. The tokens “*”, “+”, “(“, and “)” do not inherit from “IE” because there is no sequence of unit productions from “E” that produce them. This makes sense, because they are not expressions but rather parts of expressions.

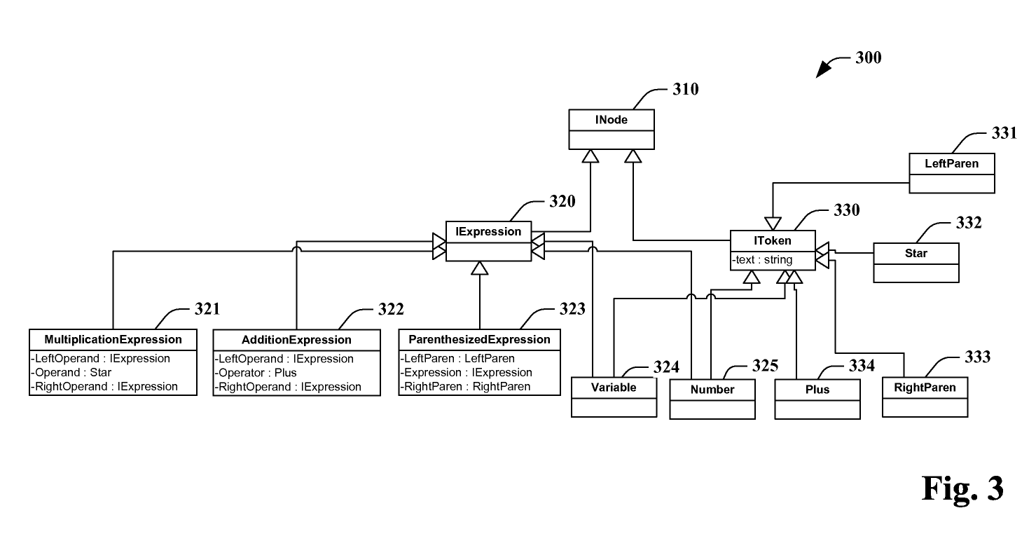

Referring to FIG. 3, an object model 300 produced for the exemplary grammar is depicted in the Unified/Urniversal Modeling Language (UML), which comprises special graphical notation utilized to create an abstract model of a system. As shown, there are a number of interface types or classes and subclasses. The root is “INode” 310, which includes children or dependent interfaces “Iexpression” 320 and “IToken” 330. “MultiplicationExpression” 321, “AdditionExpression” 322, “ParenthesizedExpression” 324, “Variable” 325, and “Number” 326 allow depend from or implement the “Iexpression” 320 interface. “Variable” 325 and “Number” 326 as well as “LeftParen” 331, “Star” 332, “RightParen” 333 and “Plus” 334 all depend from or implement the “IToken” 330 interface.

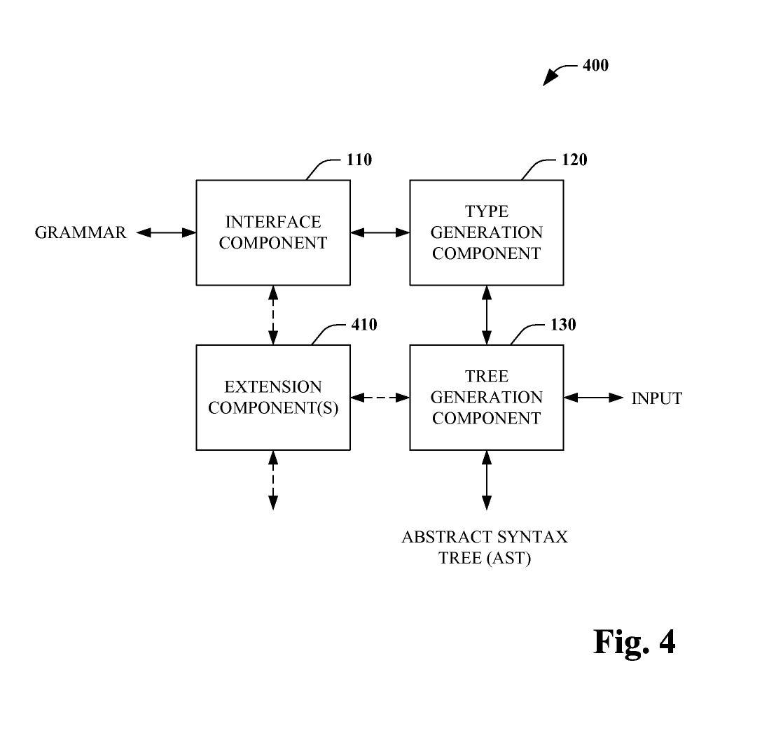

Turning to FIG. 4, a parser generation system 400 is illustrated in accordance with an aspect of the claimed subject matter. Similar to system 100 of FIG. 1, the system 400 includes the interface component 110, type generation component 120, and tree generation component 130, as previously described. In brief, the interface component 110 makes a grammar available to the type generation component 120, which automatically generates types and/or other programmatic constructs to facilitate construction of an abstract syntax tree by the tree generation component 130. Further, the system 400 includes one or more extension components 410 to facilitate consumption and/or production of AST types, among other things. Depending upon the particular extension component 410 access can be provided to the grammar and/or AST.

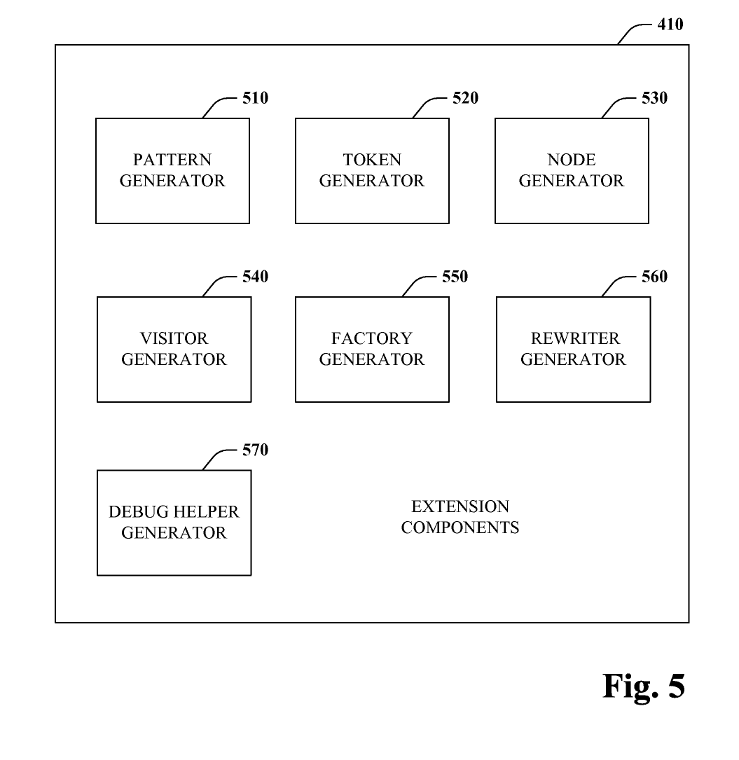

Referring to FIG. 5, a plurality of individually numbered exemplary extension components 410 or embodiments thereof are illustrated in accordance with an aspect of the claimed subject matter. Of course, any combination of such extension components 410 can be employed, and other components are also possible. Pattern generator component 510 provides a mechanism to identify and encode grammatical patterns. For example, the component 510 can identify and encode common patterns such as optionality, lists, and zippered lists. For example, optionality refers to a scenario where something is left to choice. In particular, a production can have a non-terminal that goes to something or nothing (empty production). In this case, the type can be encoded as optional and parameterized by the type of the thing that could have possibly occurred. Additionally or alternatively, the pattern generator component 510 can infer or otherwise find patterns from the grammar or elsewhere and encode them of use in a first class manner. Furthermore, these patterns can be abstracted to build up bigger structures.

Token generator component 520 is a mechanism that generates canonical representations of tokens. A canonical representation of a token can be produced by mechanically expanding a regular expression corresponding to a token, among other ways. Regular expressions include six operators at their core: kleene star, concatenation, union, entity, null, and empty. A representative token can be produced in terms of these operations in the following manner: kleene star—produce nothing; concatenation—if either left or right is null produce null otherwise produce left and then produce right; union—produce left; entity—produce entity; empty—produce nothing; null—produce null.

Node generator 530 produces a canonical representation of one or more nodes of an AST. This provides a minimal representation or token that is a valid instance of a production. In accordance with one embodiment, the canonical representation can be determined by running a fixed-point algorithm over the grammar (e.g., context free). Each token can be given the weight of one and each empty production the weight zero. Now for each non-terminal that uses a production of symbols with known weights, the non-terminal is assigned the weight of the sum of the symbol's costs and the production choice is encoded. The process can proceed until a fixed-point is reached, which will be the case if there exists a finite expansion for the non-terminal. For each non-terminal, the canonical representation can be a production that was marked.

To facilitate clarity and understand with respect to how a canonical representation can be produced, consider the continually referenced exemplary grammar above. Starting from the bottom, a determination can be made regarding the non-terminal “F”. The shortest production is either a variable or a number, which can be arbitrarily selected. Suppose variable is selected. Now, the shortest production for “T” is the shortest either of “F” or “T”. Since “T” includes a multiple of “F”, it is longer than “F”. For similar reasons, “E” is also longer than “T.” Accordingly, the shortest production for “E”, “T”, and “F” is variable.

The canonical representation is often used to synthesize tokens and nodes. Suppose that a parser receives an erroneous program as input, which is more often than not the case where the parser is employed with respect to an IDE, for instance. The parser will thus need to create a fake node in order to complete successfully (e.g., recover from error). To do this, the parser can synthesize nodes and tokens in their canonical representation.

Visitor generator component 540 constructs one or more visitors to visit or access tree nodes and optionally perform some action. Various kinds of visitors can be generated including pre-order and post-order visitors, default visitors, or Visitor <T>. Order visitors can traverse children of a node in a pre-order or post-order way. A default visitor can be generated and overridden to enable access to a particular node type. Vistor<T> can visit a node and return a “T”, which can be employed with respect to node evaluation, among other things.

Factory generator component 550 constructs one or more factories that employ type information and possibly canonical representations to generate synthesized or real nodes or token. In one embodiment, factories can return interfaces that correspond to concrete types instead of the concrete types themselves. In this manner, different factories can be applied. Trees can be constructed based on modified or custom types.

One example of factory use is for error recovery. Suppose that during parsing an error is encountered. A parse tree should not be left in an unknown state, especially where employed in IDE. Accordingly, a factory can be used to automatically synthetic nodes or trees utilizing a minimal or canonical representation.

Rewriter generator component 560 constructs one or more rewriters that perform minimal or other rewriting of abstract syntax tree nodes. For example, minimal rewriters can be generated that allow overriding of a particular node and replacing it with a different node, which causes only the parents of the node to be rewritten. This supports immutable type systems. More specifically, where an abstract syntax tree is immutable a change requires generation of another version of the tree or a portion thereof. Where a change is made to a node, the parent nodes can be rewritten.

Debug helper component 570 produces one or more programmatic constructs to aid a debugging of types and abstract syntax trees, among other things. Abstract syntax trees can be complicated and difficult to debug. Accordingly, debug visualizers and/or type proxies can be created to provide a more user-friendly view of what is going on. For instance, unneeded information can be filtered or presented in a better manner. By way of example, consider an expression “4+2”. If this is analyzed in a visual debugger, there might be an expression object, with something on the left and something on the right. The visualizer could reconstruct the text for that expression “4+2”, which would be much more helpful than forcing a user to drill down to determine what is happening.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the type generation component 120 can utilize such mechanisms to determine or infer appropriate types and/or constructs for production from a grammar. In other words, the mechanisms can be employed to facilitate reasoning or further reasoning over a grammar such that the resultant object model, for example, is close to that which would have been hand-written by a developer as opposed to performing a naïve translation. Furthermore, the pattern generator component 510 can employ such mechanisms to determine, infer, or otherwise locate patterns within a grammar.

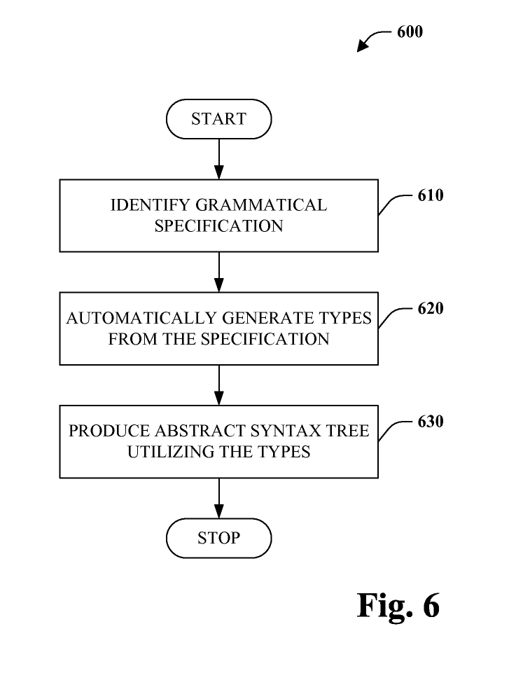

In view of the exemplary systems described supra, methodologies that may be implemented in accordance with the disclosed subject matter will be better appreciated with reference to the flow charts of FIGS. 6-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a parser generation method 600 is illustrated in accordance with an aspect of the claimed subject matter. At reference numeral 610, a grammar or grammatical specification is identified such as that associated with a natural or program languages and/or data. At numeral 620, types and/or other programmatic constructs associated with generation of an abstract syntax tree are generated automatically from the grammar or specification. In accordance with one embodiment, object-oriented constructs including interfaces and concrete data types can be employed to produce or otherwise comprise an object model for a syntax tree. Furthermore, the object model can be closer to what a human would hand write than to conventional automated approaches. At reference numeral 630, an abstract syntax tree is produced as a function of an input and the automatically generated types and the like.

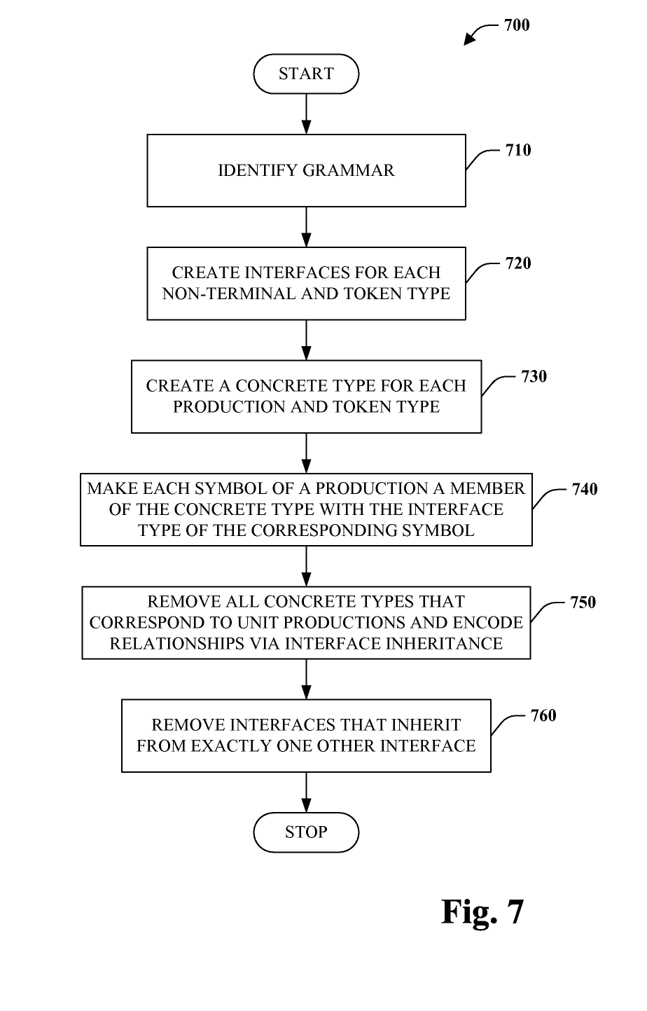

FIG. 7 depicts a method of automatic type generation 700 in accordance with an aspect of the claimed subject matter. At reference numeral 710, a grammar is identified such as but not limited to a program language grammar. At numeral 720, an interface, a form of abstract class or type, is created for each non-terminal and token/token type of the grammar. At 730, a concrete data type is produced for each production and token type. At reference 740, each symbol of a production is made a member of the concrete type with the interface type of the corresponding symbol. All concrete types that correspond to unit productions are removed and the relationship is captured by way of inheritance through interfaces at numeral 750. At 760, interfaces are removed that inherit from exactly one other interface.

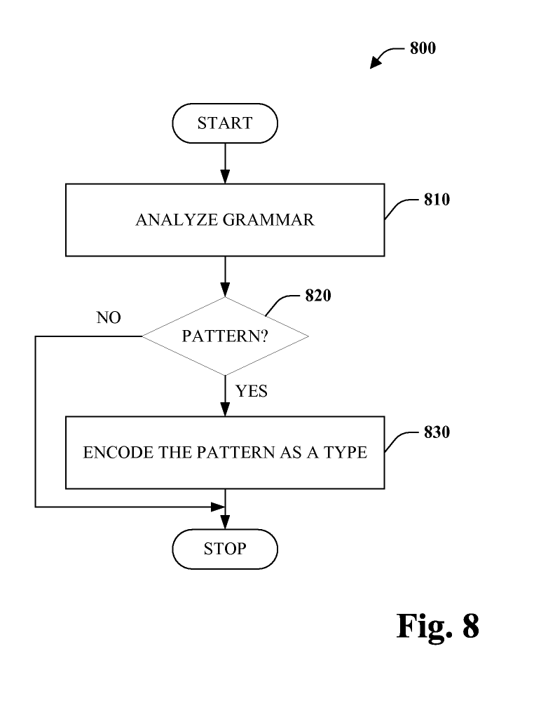

Referring to FIG. 8, a method of automatic pattern encoding 800 is shown according to an aspect of the claimed subject matter. At reference numeral 810, a grammar or grammar specification is analyzed. A determination is made at 820 as to whether the analysis identified any patterns in the grammar. If no, the method simply terminates or alternatively continues to analyze the grammar (not shown). If yes, the method continues at 830 where the pattern is encoded as a type or other programmatic structure.

In one instance, the method 800 can be employed to identify and automatically generate common patters such as optionality, lists, and/or zippered lists. By way of example, suppose there is a production that specifies that a non-terminal goes to something and nothing (empty production). That means you have optionality at that point. Hence, a type can be encoded as being optional and parameterized by the type of the thing that could have possibly occurred. Therefore, if it were an “X” or a “Y” and “Y's” type is “foo”, it could be optional “foo”. In the list example, if there is a list of parameters being passed to a function call, in the syntax tree that list of parameters is going to be a little tree of its own, but that is not the most useful way to deal with it. Instead of providing a tree structure that represents this list of parameters, a type can be generated that is a simple list of these parameters. In fact, since parameters are often separated by commas, a zippered list can be generated where the parameters are zipped with corresponding commas.

In addition to common patterns, the method 800 can detect uncommon or less common patterns utilizing inference, machine learning, or the like Furthermore, inference need not be limited to the grammar. Commonly recurring input patterns can be identified and encoded. Further, identified patterns can be abstracted to provide bigger structures that can be employed in a first class way. In general, patterns can be detected for which specific types can be generated.

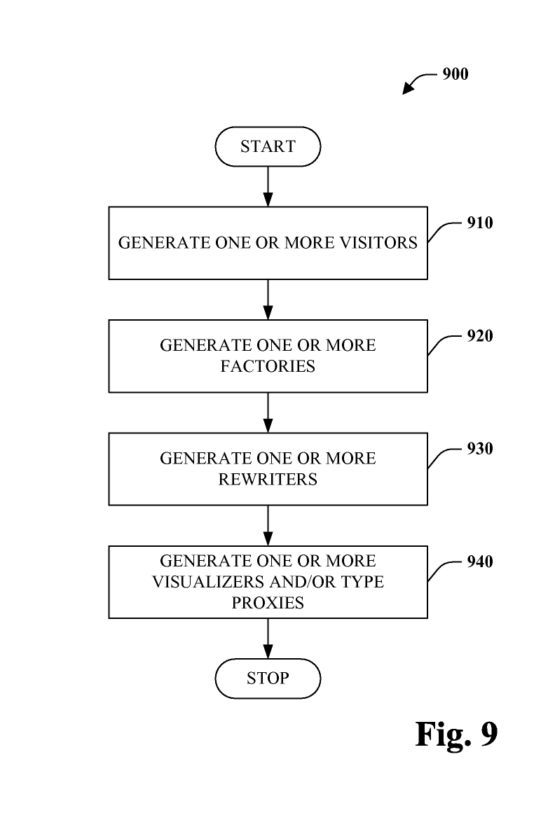

FIG. 9 is method of extension generation 900 in accordance with an aspect of the claimed subject matter. At reference numeral 910, one or more visitor constructs are generated. Such constructs can correspond to a visitor design pattern and provide the ability to access types or tree nodes, inter alia. Further, visitors can be various types including default, pre-order or post-order and production visitor, among others. One or more factories can be generated at numeral 920. These are constructs that correspond to a factory design pattern and facilitate production of one or more types or nodes. For example, synthetic nodes can be generated by a factory to aid recovery from one or more errors. At numeral 930, one or more rewriters are constructed to facilitate rewriting one or more nodes or sub-trees associated with a new tree in an immutable system, for instance. At 940, one or more helper constructs such visualizers and/or type proxies are produced to aid debugging. For example, an easily comprehendible view of a tree can be produced and a filter employed to bubble up relevant information.

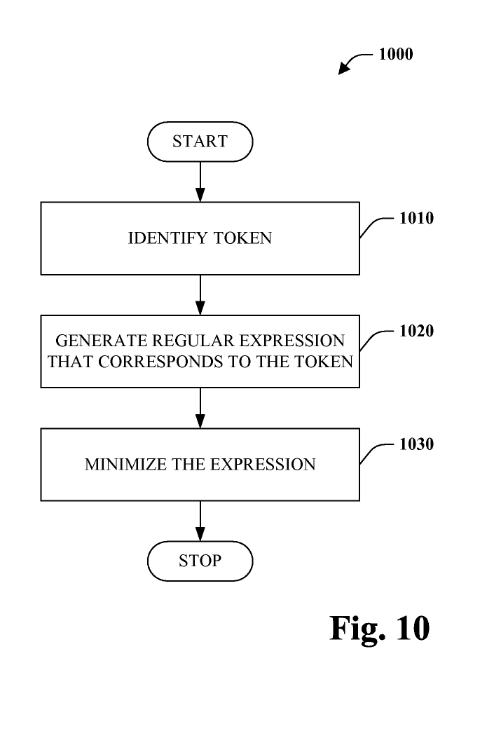

FIG. 10 is a diagram of a method of generating a canonical representation of a token 1000 in accordance with an aspect of the claimed subject matter. A canonical representation defines the minimum valid token that can be synthetically generated to recover from an error. At reference numeral 1010, a token can be identified. A regular expression associated with the identified token can be identified or otherwise generated at reference numeral 1020. This regular expression is minimized at 1030. Regular expressions include six operators at their core: kleene star, concatenation, union, entity, null, and empty. A representative token can be produced in terms of these operations in the follow manner: kleene star—produce nothing; concatenation—if either left or right is null produce null otherwise produce left and then produce right; union—produce left; entity—produce entity; empty—produce nothing; null—produce null.

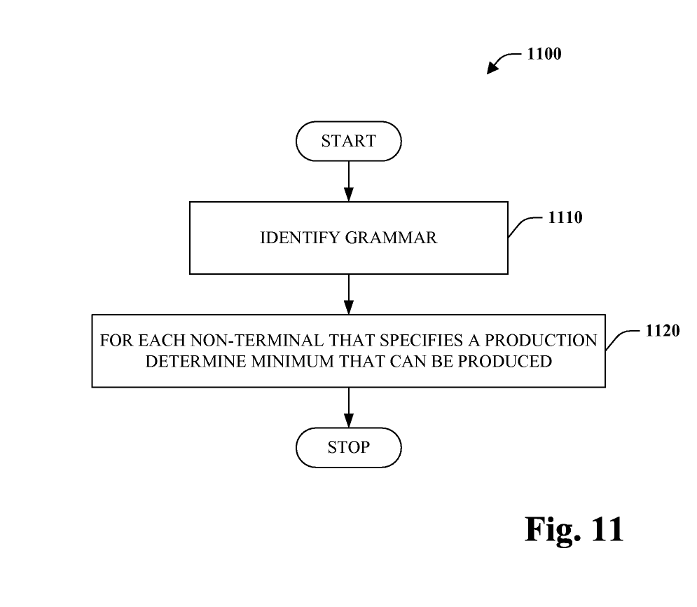

FIG. 11 is a flow chart diagram of a method of producing a canonical representation of an abstract syntax tree node 1100 in accordance with an aspect of the claimed subject matter. At reference numeral 1110, a grammar or grammar specification is accessed. For each non-terminal node that specifies a production, a minimum node that can be produced is determined at numeral 1110. This minimum is the canonical representation or synthetic version of a node. That can be utilized to recover from errors, among other things. For example, suppose that a parser receives an erroneous program as input. In this case, the parser will need to create a fake node in order to complete successfully complete parsing. To do this, the parser can synthesize nodes (and tokens) in their canonical representation. Many different techniques can be employed to generate this representation, but in general, it involves iterating through the grammar and keeping track of the minimum valid representation for each node.

In accordance with one embodiment, a fixed-point algorithm can be employed that assigns weights to nodes. Initially, each token is assigned a weight of one and each empty production a weight of zero, for example. For each production, the minimum that it can produce is determined. In other words, for each production comprising a number of symbols of known weights, the sum of symbol weights can be computed and encoded for that production choice. At first, the smallest productions, the ones that just use terminals, will be known. Next, this information is propagated to productions that depend on those terminals and so one. Productions continue to be built up using known minimums until a fixed point is reached where all minimums are known. These minimums can then be recorded as well as paths that can be followed to those minimums, for instance.

It is to be appreciated that various examples and discussion supra focus on programmatic code solely for purpose of clarity and understanding. Various systems and methods associated with type generation and abstract syntax tree production, consumption, and/or debugging can be employed with respect not only to computer or programmatic code but also to natural languages as well as data (e.g., XML (eXtensible Markup Language, JSON (JavaScript Object Notation, comma-separated values . . . )

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

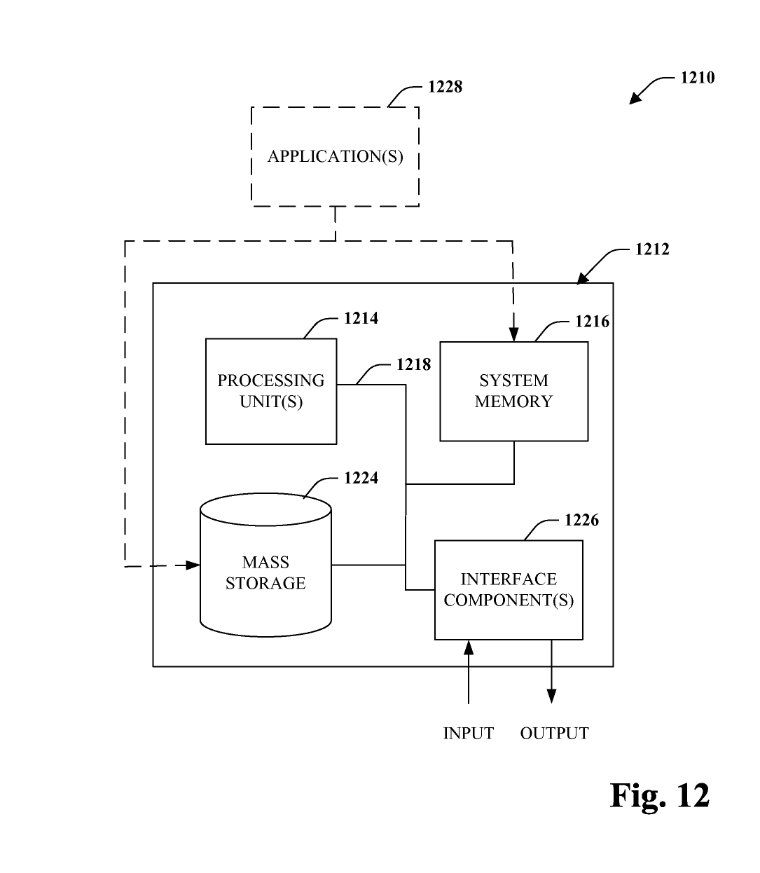

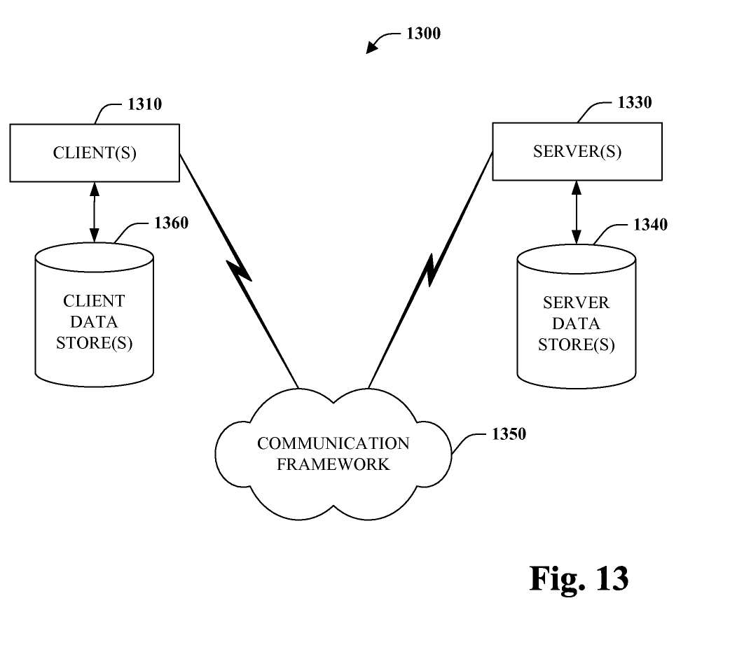

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. It is to be appreciated that dual microprocessors, multi-core and other multiprocessor architectures can be employed as the processing unit 1214.

The system memory 1216 includes volatile and nonvolatile memory. The basic input/output system (BIOS), containing the basic routines to transfer information between elements within the computer 1212, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1212 also includes removable/non-removable, volatile/non-volatile computer storage media. FIG. 12 illustrates, for example, mass storage 1224. Mass storage 1224 includes, but is not limited to, devices like a magnetic or optical disk drive, floppy disk drive, flash memory, or memory stick. In addition, mass storage 1224 can include storage media separately or in combination with other storage media.

FIG. 12 provides software application(s) 1228 that act as an intermediary between users and/or other computers and the basic computer resources described in suitable operating environment 1210. Such software application(s) 1228 include one or both of system and application software. System software can include an operating system, which can be stored on mass storage 1224, that acts to control and allocate resources of the computer system 1212. Application software takes advantage of the management of resources by system software through program modules and data stored on either or both of system memory 1216 and mass storage 1224.

The computer 1212 also includes one or more interface components 1226 that are communicatively coupled to the bus 1218 and facilitate interaction with the computer 1212. By way of example, the interface component 1226 can be a port (e.g., serial, parallel, PCMCIA, USB, FireWire . . . ) or an interface card (e.g., sound, video, network . . . ) or the like. The interface component 1226 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1212 to output device(s) via interface component 1226. Output devices can include displays (e.g., CRT, LCD, plasma . . . ), speakers, printers and other computers, among other things.

FIG. 13 is a schematic block diagram of a sample-computing environment 1300 with which the subject innovation can interact. The system 1300 includes one or more client(s) 13 10. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the aspects of the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

Client/server interactions can be utilized with respect with respect to various aspects of the claimed subject matter. By way of example and not limitation, one or more of the above described components, systems or methods can be embodied as a network services provided by one or more servers 1330 to one or more clients 1310 across communication framework 1350. For instance, the type generation component 130 can be a network or web service that receives a grammar and returns types and/or other programmatic constructs to generate an abstract syntax tree. In another instance, extension components can be provided across the communication framework 1350 system plug-ins.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An automatic parser generator system, comprising:
an interface component to afford access to a grammatical specification; and
a type generation component that automatically generates types from the grammatical specification in a manner that resembles human generation to facilitate construction of an abstract syntax tree.

2. The system of claim 1, further comprising a component that automatically generates an abstract syntax tree for a given input based at least in part of the generated types.

3. The system of claim 1, further comprising a component that detects grammatical design patterns in the grammatical specification and encodes the patterns.

4. The system of claim 1, further comprising a component that generates a canonical representation of one or more tokens.

5. The system of claim 1, further comprising a component that generates a canonical representation for a tree node.

6. The system of claim 1, further comprising a component that produces one or more visitors to facilitate access to tree nodes and optional performance of an action.

7. The system of claim 1, further comprising a component that constructs one or more factories that facilitate generation of abstract syntax trees, sub-trees, nodes, and/or tokens.

8. The system of claim 1, further comprises a component that generates one or more rewriters that perform minimal rewrites of tree nodes.

9. The system of claim 1, further comprising a component that generates one or helper methods or functions that aid debugging of abstract syntax tree types.

10. An object-oriented method of automatic parser generation, comprising:
constructing types for an abstract syntax tree from a grammar including concrete data types and interfaces automatically in a manner that resembles hand-written specification; and
generating an abstract syntax tree as a function of the constructed types.

11. The method of claim 10, further comprising:
generating an interface for each non-terminal and token type;
constructing a concrete data type for each token type and non-unit production;
encoding unit productions utilizing inheritance amongst interfaces; and
removing interfaces that inherit from exactly one other interface.

12. The method of claim 10, further comprising automatically generating common grammatical design patterns including at least one of optionality, lists, and zippered lists.

13. The method of claim 10, further comprising generating a canonical representation of tokens.

14. The method of claim 10, further comprising generating a canonical representation of abstract syntax tree nodes.

15. The method of claim 10, further comprising generating one of more visitors to access the abstract syntax tree and optionally perform an action.

16. The method of claim 10, further comprising constructing one or more factories that employ type information to produce synthesized or real nodes and tokens.

17. The method of claim 10, further comprising generating one or more rewriters that enable rewriting of parent nodes of the abstract syntax tree upon override or replacement of a node in an immutable system.

18. The method of claim 10, further comprising generating a visualizer and/or type proxy to facilitate at least one of tree visualization or debugging.

19. A parser generation method employing automatic grammar-based generation of types, comprising:
generating an interface for each non-terminal and token of a grammar;
generating a concrete data type for each production and token of the grammar;
removing the concrete data types for unit productions;
encoding a unit production by way of inheritance amongst interfaces; and
removing interfaces that inherit from exactly one other interface.

20. The method of claim 10, further comprising automatically constructing an abstract syntax tree as a function of resultant interfaces and concrete types.
